(19) United States
(12) Patent Application Publication
(10) Pub. No.: US 2025/0275519 A1
(43) Pub. Date: Sep. 4, 2025

(54) Pet Toy System and Apparatus

(71) Applicant: Huxley & Kent LLC, Knoxville, TN (US)

(72) Inventors: Elizabeth Bentz, Denver, CO (US); Geoffrey Robert Quinter, Aurora, CO (US); Hing Chau Lam, Gatley Stockport (GB)

(73) Assignee: Huxley & Kent LLC, Knoxville, TN (US)

(21) Appl. No.: 19/067,711

(22) Filed: Feb. 28, 2025

Related U.S. Application Data
(60) Provisional application No. 63/559,530, filed on Feb. 29, 2024.

(51) Int. Cl. A01K 15/02

(52) U.S. Cl. CPC A01K 15/025

(57) ABSTRACT

Embodiments of the present invention are directed toward an improved pet toy system and/or apparatus for cats and other animals comprising an ergonomically shaped handle configured to accept a slender wire-like wand that has a cat (or other animal) toy attached to its distal end and a docking plug interoperably attached or permanently affixed to its proximal end, such that the docking plug (along with its associated wand) can be repeatedly inserted into and removed from a docking seat located within a longitudinal center hole in the handle, thereby facilitating an easy switch between different wands and/or toys while using the same ergonomic handle.

### CROSS REFERENCE TO RELATED APPLICATIONS

This application claims priority under 35 U.S.C. § 119(e) to U.S. Provisional Patent Application No. 63/559,530, entitled “Cat Wand Toy Handle,” filed on Feb. 29, 2024.

### FIELD OF THE INVENTION

Embodiments of the present invention relate generally to toys for the entertainment of pets and other animals, and more specifically to a handle apparatus for holding interchangeable wands upon which many different cat and other animal toys can be attached.

### BACKGROUND

Current pet toys are often permanently bound to a handle. This creates an issue, because through the normal use of pet toys, the pet attractor can become damaged and may therefore fall apart over time, necessitating the replacement of the entire pet toy and handle. This wasteful design generates excessive waste and additional costs for the consumer.

Additionally, pets can have different and shifting preferences, and in order to provide additional stimuli, a pet owner will typically own multiple pet toys, each with its own bound handle. Such a unitary, permanently bound handle design creates logistical problems for consumers in terms of requiring additional space for storing pet toys and increased costs of purchasing multiple toys with handles.

### SUMMARY OF THE INVENTION

This summary is provided to introduce certain concepts in a simplified form that are further described below in the Detailed Description. This summary is not intended to identify key features or essential features of the claimed subject matter, nor is it intended to limit in any way the scope of the claimed invention.

Embodiments of the present invention provide an improved system and/or apparatus for pet toys (and other animal toys) comprising at least two parts: (1) a handle having a length between 4 and 6 inches with a generally elliptical cross section with a tapered diameter along its length of between 0.5 and 0.7 inches, with an ergonomic shape that can easily be held in a human hand, with an ergonomic indentation having a depth between 0.5 mm and 1.5 mm to allow a person to more easily hold the handle, and including on its distal end an approximately 2 mm to 5 mm opening to a centered internal longitudinal cavity that is approximately 4 to 6 inches deep and approximately 2 mm to 5 mm in diameter; within which (2) a wand of any length featuring a pet toy on its distal end and a docking plug on its proximal end. According to embodiments, the wand can be inserted into the handle, with said docking plug being suitably sized to fit snugly within the longitudinal cavity of the handle. The material of the handle and the docking plug should be sufficiently elastic such that the wand with its connected docking plug can be repeatedly inserted into the handle and removed from the handle without compromising the integrity of the handle cavity. The material of the handle and the docking plug should also be sufficiently rigid to enable the wand to be snuggly held in the handle during normal anticipated use. Embodiments may have more than one longitudinal cavity to accommodate more than one wand at a time.

Embodiments of the present invention also provide an improved handle for pet toys (and other animal toys) comprising at least three parts: (1) a handle having a length between 4 and 6 inches with a generally elliptical cross section with a tapered diameter along its length of between 0.5 and 0.7 inches, with in ergonomic shape that can easily be held in a human hand, with an indentation having a depth between 0.5 mm and 1.5 mm to ergonomically hold the handle, and including on its distal end an approximately 2 mm to 5 mm opening to a centered internal longitudinal cavity that is approximately 4 to 6 inches deep and approximately 2 mm to 5 mm in diameter, within which (2) a docking plug can be inserted into the handle, with said docking plug being suitably sized to fit snugly within the longitudinal cavity of the handle, said docking plug further featuring a longitudinal cavity sized such that (3) a wand or wire of any length holding any number of pet toys can be interchangeably inserted into the docking plug. According to embodiments, the wand can be inserted into the handle, with said docking plug being suitably sized to fit snugly within the longitudinal cavity of the handle. The material of the handle and the docking plug should be sufficiently elastic such that the wand with its connected docking plug can be repeatedly inserted into the handle and removed from the handle without compromising the integrity of the handle cavity. The material of the handle and the docking plug should also be sufficiently rigid to enable the wand to be snuggly held in the handle during normal anticipated use. Again, embodiments may have more than one longitudinal cavity to accommodate more than one wand at a time.

The above summaries of preferred embodiments have been provided to introduce certain concepts and/or features that are further described below in the Detailed Description. The summarized preferred embodiments are not necessarily representative of the claimed invention, nor do they span the scope of features described in more detail below. They simply serve as an introduction.

### BRIEF DESCRIPTION OF THE DRAWINGS

So that the above summarized features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of an exemplary embodiment of the present invention illustrating multiple pet attractors permanently affixed to a wand which is connected to a pet toy handle with an ergonomic indentation on its distal end in accordance with the present invention.

FIG. 2 is a perspective view of an exemplary embodiment of the present invention illustrating a pet attractor attached to a wand connected to a pet toy handle with an ergonomic indentation on its distal end in accordance with the present invention.

FIG. 3 is a perspective view of an exemplary embodiment of the present invention illustrating a pet toy wand attached to a docking plug configured to be inserted into a pet toy handle featuring an ergonomic indentation on its distal end in accordance with the present invention.

FIG. 4 is an exploded sideways/sagittal cross-sectional view of an exemplary embodiment of the present invention illustrating a pet toy wand sized to be snugly inserted into a docking plug which features an internal cavity, and a pet toy handle featuring an ergonomic indentation on its distal end and a centered internal longitudinal cavity that substantially matches the docking plug such that the docking plug can be securely nested and snapped in place in accordance with the present invention.

FIG. 5 is a sideways/sagittal cross-sectional view of an exemplary embodiment of the present invention illustrating a pet toy wand snuggly inserted through an internal cavity of a docking plug, which is in turn snuggly nested inside a longitudinal cavity of a pet toy handle that features an ergonomic indentation on its distal end in accordance with the present invention.

FIG. 6 is a perspective view of an exemplary embodiment of the present invention illustrating a pet toy handle featuring an opening on its distal end to accept the insertion of pet toy wands, and multiple ergonomic indentations in accordance with the present invention.

FIG. 7 is a sideways/sagittal cross-sectional view of an exemplary embodiment of the present invention illustrating a pet toy handle featuring a centered internal longitudinal cavity which is open on the distal end and closed on the proximal end, the longitudinal cavity further featuring a multi-diameter portion at the distal end to serve as a docking seat for accepting and snuggly nesting a docking plug in accordance with the present invention.

FIG. 8 is a perspective axial view looking directly at the distal end of an exemplary embodiment of the present invention illustrating a pet toy handle featuring a centered internal longitudinal cavity for the insertion of pet toy wands, where the longitudinal cavity is open on the distal end and closed on the proximal end, where the pet toy handle further has a multi-diameter, generally cylindrical, distal end with diametrically opposing ergonomic indentations near the distal end, and the proximal end of the pet toy handle having a generally elliptical cross section with its major axis radially offset from the ergonomic indentations in accordance with the present invention.

FIG. 9 is a perspective axial view looking directly at the proximal end of an exemplary embodiment of the present invention illustrating a pet toy handle featuring a closed proximal end which has a generally elliptical cross section, and a generally cylindrical distal end in accordance with the present invention.

FIG. 10 is a perspective view of an exemplary embodiment of the present invention illustrating a docking plug with a longitudinal cavity for the insertion of a pet toy wand and a center portion having an expanded outer diameter to substantially mirror and match the diameter of a docking plug seat inside a longitudinal cavity of a pet toy handle such that the docking plug can be securely nested inside the handle in accordance with the present invention.

FIG. 11 is a sideways/sagittal cross-sectional view of an exemplary embodiment of the present invention illustrating a vertically symmetric docking plug such that its proximal and distal ends substantially match, allowing it to be orientation-independently inserted into a longitudinal cavity of a pet toy handle, said symmetric docking plug further having a longitudinal cavity for the insertion of a pet toy wand and a center portion having an expanded outer diameter to substantially mirror and match the diameter of a docking plug seat inside of a longitudinal cavity of a pet toy handle such that the docking plug can be securely nested inside a pet toy handle in accordance with the present invention.

FIG. 12 is a sideways/sagittal cross-sectional view of an exemplary embodiment of the present invention illustrating a pet toy wand snugly inserted into a longitudinal cavity of a docking plug, which is securely nested within a docking plug seat of a centered internal longitudinal cavity of a pet toy handle in accordance with the present invention.

FIG. 13 is a sideways/sagittal cross-sectional view of an exemplary embodiment of the present invention illustrating an asymmetric, orientation-dependent docking plug with an expanded distal end inserted into and securely nested within a docking plug seat inside of a longitudinal cavity of a pet toy handle in accordance with the present invention.

### DESCRIPTION OF THE EMBODIMENTS

Embodiments of the present invention will be described with reference to the accompanying drawings, wherein like parts are designated by like reference numerals throughout, and wherein the leftmost digit(s) of each reference number refers to the drawing number of the figure in which the referenced part first appears. Embodiments of the invention are not limited in their application to the details of construction or to the arrangement of the components set forth in the following description or illustrated in the drawings. Embodiments of the invention are capable of being practiced and carried out in various ways. In addition, the phraseology and terminology employed herein are for the purpose of description and should not be regarded as limiting.

As summarized above, preferred embodiments of the present invention provide an improved pet toy wand handle principally comprising a centered internal longitudinal activity configured to accept interchangeable wands to attach pet attractors (the pet attractors themself are not part of the claimed invention).

### Interchangeable Wands to Attach Pet Attractors

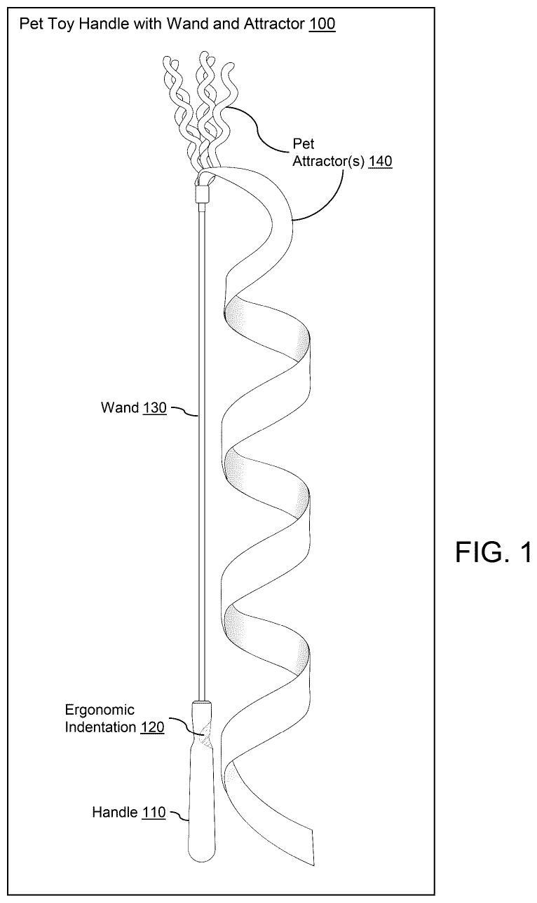

FIG. 1 is a perspective view of an exemplary embodiment of the present invention illustrating multiple pet attractors permanently affixed to a wand which is connected to a pet toy handle with an ergonomic indentation on its distal end in accordance with the present invention.

More specifically, FIG. 1 is a perspective view of an exemplary embodiment of the present invention illustrating multiple pet attractors 140 permanently affixed to a wand 130 which is connected to a pet toy handle with an ergonomic indentation on its distal end in accordance with the present invention.

Referring to FIG. 1, an assembled pet toy system 100 may include handle 110 with interoperably attached wand 130, inserted into the distal end of handle 110 and pet attractors 140 affixed to the distal end of wand 130.

As shown in FIG. 1, handle 110 may feature ergonomic indentation 120 near its distal end.

As further shown in FIG. 1, wand 130 may feature multiple pet attractors 140 affixed to its distal end.

Preferentially, handle 110 is operated by a human. Ergonomic indentation 120 on handle 110 may increase the comfort of the operator and may allow the operator to control handle 110 with greater precision and dexterity, given the increased torque the operator may be allowed to apply to handle 110 through ergonomic indentation 120.

Preferentially, wand 130 is of a suitable length such that pet attractor 140 is sufficiently distanced from the human operator such that the cat or other animal may does not represent a risk to the operator's safety.

Preferentially, handle 110 has an ergonomic shape that can easily be held in a human hand. Handle 110 may have a length between 4 and 6 inches with a generally elliptical cross section with a tapered diameter along its length of between 0.5 and 0.7 inches and ergonomic indentation 120 is centered 0.3-0.7 inches away from the distal end of handle 110. Alternative sizes and arrangements are possible, these noted measurements and configurations are merely those of preferred exemplar embodiments.

Preferentially, ergonomic indentation 120 has a depth of between 0.5 mm and 1.5 mm. Alternative sizes are possible, these noted measurements are merely those of preferred exemplar embodiments.

Preferentially, wand 130 has a diameter of between 0.005 and 0.01 inches and a length between 24 and 48 inches. Alternative sizes are possible, these noted measurements are merely those of preferred exemplar embodiments.

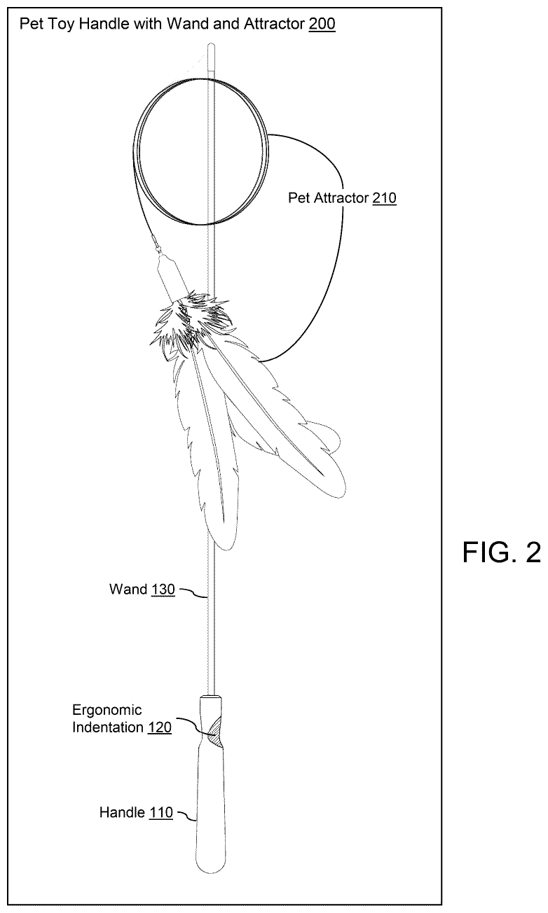

FIG. 2 is a perspective view of an exemplary embodiment of the present invention illustrating a pet attractor attached to a wand connected to a pet toy handle with an ergonomic indentation on its distal end in accordance with the present invention.

More specifically, FIG. 2 is a perspective view of an exemplary embodiment of the present invention illustrating pet attractor 210 attached to wand 130 connected to pet toy handle 110 with ergonomic indentation 120 on its distal end in accordance with the present invention.

Referring to FIG. 2, an assembled pet toy system 200 may include handle 110 with interoperably attached wand 130 inserted into the distal end of handle 110, and pet attractor 210 attached to the distal end of wand 130.

As shown in FIG. 2, handle 110 may feature ergonomic indentation 120 near its distal end.

As further shown in FIG. 2, wand 130 may feature attachable pet attractor 210 at its distal end.

Preferentially, handle 110 is operated by a human. Ergonomic indentation 120 on handle 110 may increase the comfort of the operator and may allow the operator to control handle 110 with greater precision and dexterity, given the increased torque the operator may be allowed to apply to handle 110 through the ergonomic indentation 120.

Preferentially, wand 130 is of a suitable length such that attachable pet attractor 210 is sufficiently distanced from the human operator such that the cat or other animal may does not represent a risk to the operator's safety.

Preferred sizes and configurations for preferred exemplar embodiments are discussed throughout and alternative sizes and arrangements are possible, these noted measurements and configurations are merely those of preferred exemplar embodiments.

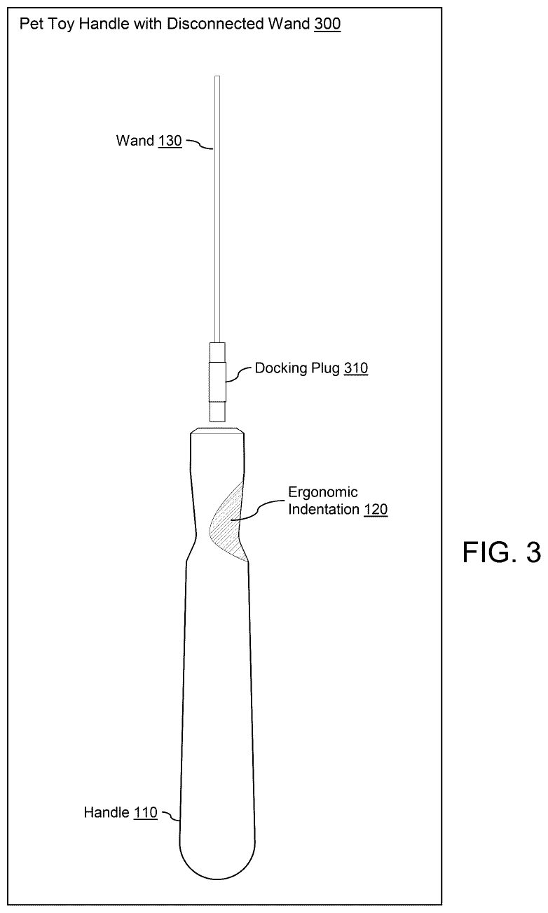

FIG. 3 is a perspective view of an exemplary embodiment of the present invention illustrating a pet toy wand attached to a docking plug configured to be inserted into a pet toy handle featuring an ergonomic indentation on its distal end in accordance with the present invention.

More specifically, FIG. 3 is a perspective view of an exemplary embodiment of the present invention illustrating pet toy wand 130 attached to docking plug 310 configured to be inserted into pet toy handle 110 featuring ergonomic indentation 120 on its distal end in accordance with the present invention.

Referring to FIG. 3, an unassembled pet toy system 300 may include handle 110 and pet toy wand 130 affixed to docking plug 310. Docking plug 310 may be suitably sized to be inserted into the distal end of handle 130.

As shown in FIG. 3, handle 110 may feature ergonomic indentation 120 on its distal end. As shown in FIG. 3, wand 130 does not necessarily include an affixed pet attractor.

As shown in FIG. 3, wand 130 may include affixed docking plug 310.

Preferentially, handle 110 is operated by a human. Ergonomic indentation 120 on handle 110 may increase the comfort of the operator and may allow the operator to control handle 110 with greater precision and dexterity, given the increased torque the operator may be allowed to apply to handle 110 through the ergonomic indentation 120.

Preferentially, handle 110 may feature an open cavity capable of accepting docking plug 310 such that docking plug 310 may be securely held in place through static friction.

Preferentially, docking plug 310 has a diameter of between 2 mm and 5 mm, with a central portion that has a diameter 0.5 mm larger than the rest of docking plug 310 and a length of 0.5 inches. Alternative sizes are possible, these noted measurements are merely those of preferred exemplar embodiments.

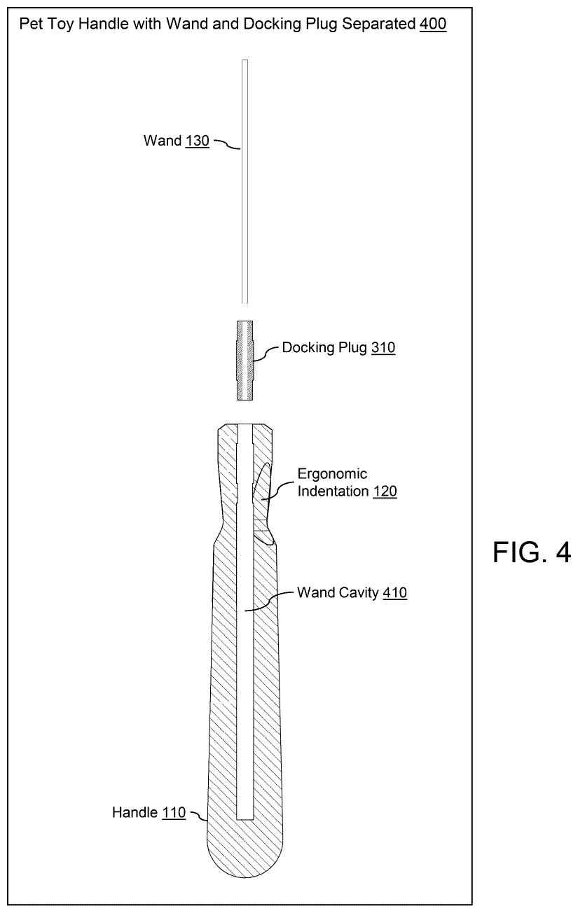

FIG. 4 is an exploded sideways/sagittal cross-sectional view of an exemplary embodiment of the present invention illustrating a pet toy wand sized to be snugly inserted into a docking plug which features an internal cavity, and a pet toy handle featuring an ergonomic indentation on its distal end and a centered internal longitudinal cavity that substantially matches the docking plug such that the docking plug can be securely nested and snapped in place in accordance with the present invention.

More specifically, FIG. 4 is an exploded sideways/sagittal cross-sectional view of an exemplary embodiment of the present invention illustrating pet toy wand 130 sized to be snugly inserted into a docking plug 310 which features an internal cavity, and pet toy handle 110 featuring ergonomic indentation 120 on its distal end and centered internal longitudinal cavity 410 that substantially matches docking plug 310 such that docking plug 310 can be securely nested and snapped in place in accordance with the present invention.

Referring to FIG. 4, an unassembled pet toy system 400 may include handle 110, docking plug 310, and wand 130. Handle 110 may include a centered internal longitudinal cavity 410 for retaining holding wand 130 through static friction. Cavity 410 may be configured to accept docking plug 310, which in turn may be configured to accept and snugly secure wand 130 through static friction.

As shown in FIG. 4, handle 130 may feature ergonomic indentation 120 on its distal end. As shown in FIG. 4, wand 130 does not necessarily include an affixed pet attractor.

As shown in FIG. 4, docking plug 310 may be separated from wand 130.

Preferentially, handle 110 should be made out of a suitably elastic material as discussed below, such that 310 docking plug may be inserted and removed from handle 110 without causing damage to handle 110 or cavity 410.

Preferentially, cavity 410 is sufficiently deep about its vertical axis such that wand 130 can be inserted sufficiently deep such that after wand 130 is inserted into docking plug 310, wand 130 does not become dislodged from docking plug 310 when a limited pulling force is applied to wand 130, which may occur during the normal anticipated use of the invention.

Preferentially, docking plug 310 features a centered internal longitudinal cavity open on both the proximal end and distal end such that wand 130 may be fully inserted into plug 310 and once inserted, wand 130 may be pulled from either the proximal or the distal end.

Preferentially, docking plug 310 features a centered internal longitudinal cavity is between 0.005 and 0.01 inches in diameter such that wand 130 may be fully inserted into plug 310 but once inserted, wand 130 is held snugly in place through static friction. Again, alternative sizes and arrangements are possible, these noted measurements and configurations are merely those of preferred exemplar embodiments.

Preferentially, handle 110 features cavity 410 that may have multiple diameters such that docking plug 310 may be firmly inserted into cavity 410, but prevented from being inserted too far into cavity 410 such that the walls of cavity 410 could interfere with the free movement and rotation of wand 130.

Preferentially, handle 110 features cavity 410 that has multiple diameters such that docking plug 310 may be firmly inserted into cavity 410, and docking plug 310 is resistant to pulling forces applied to 130 wand which may prevent docking plug 310 from being inadvertently removed from cavity 410 through normal anticipated use of the invention, but not such great resistance that intentionally dislodging docking plug 310 from cavity 410 may be strenuous for the average human.

Preferentially handle 110 is operated by a human. Ergonomic indentation 120 on handle 110 may increase the comfort of the operator and may allow the operator to control handle 110 with greater precision and dexterity, given the increased torque the operator may be allowed to apply to handle 110 through the ergonomic indentation 120.

Preferred sizes and configurations for preferred exemplar embodiments are discussed throughout and alternative sizes and arrangements are possible, these noted measurements and configurations are merely those of preferred exemplar embodiments.

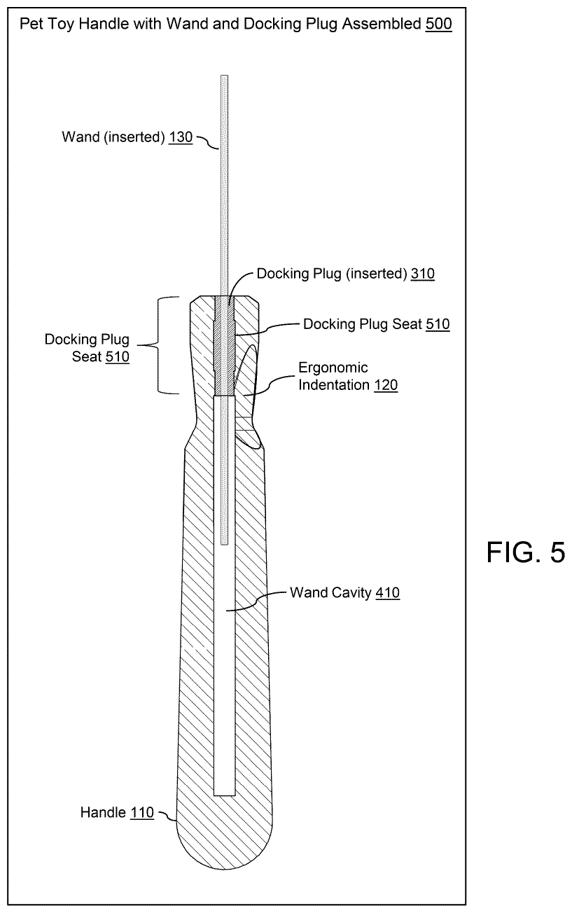

FIG. 5 is a sideways/sagittal cross-sectional view of an exemplary embodiment of the present invention illustrating a pet toy wand snuggly inserted through an internal cavity of a docking plug, which is in turn snuggly nested inside a longitudinal cavity of a pet toy handle that features an ergonomic indentation on its distal end in accordance with the present invention.

More specifically, FIG. 5 is a sideways/sagittal cross-sectional view of an exemplary embodiment of the present invention illustrating pet toy wand 130 snuggly inserted through an internal cavity of docking plug 310, which is in turn snuggly nested inside longitudinal cavity 410 of pet toy handle 110 that features ergonomic indentation 120 on its distal end in accordance with the present invention.

Referring to FIG. 5, an assembled pet toy system 500 may include handle 110, docking plug 310, and wand 130. Wand 130 is snuggly inserted through an internal cavity of docking plug 310, which is in turn snuggly nested in docking plug seat 510 inside of longitudinal cavity 410 of handle 110.

As shown in FIG. 5. docking plug 310 and longitudinal cavity 410 of handle 110 may substantially match such that docking plug 310 substantially fills and may be securely nested within designated docking plug seat 510 of longitudinal cavity 410 of handle 110.

As shown in FIG. 5, wand 130 does not necessarily include an affixed pet attractor.

As shown in FIG. 5, handle 110 may feature ergonomic indentation 120 on its distal end.

Preferentially, handle 110 should be made out of a suitably elastic material such that 310 docking plug may be inserted and removed from handle 110 without causing damage to handle 110 or cavity 410.

Preferentially, cavity 410 is sufficiently deep along its vertical axis such that wand 130 can be inserted sufficiently deep such that after wand 130 is inserted into docking plug 310, wand 130 does not become dislodged from docking plug 310 when a limited pulling force is applied to wand 130.

Preferentially, docking plug 310 features a centered internal longitudinal cavity open on both the proximal end and distal end such that wand 130 may be fully inserted into plug 310 and once inserted, wand 130 may be pulled from either the proximal or the distal end.

Preferentially, cavity 410 features docking seat 510 that has multiple diameters such that docking plug 310 may be firmly inserted into cavity 410, but the stepped diameter of docking plug seat 510 prevents docking plug 310 from being inserted too far into cavity 410 such that the walls of cavity 410 could interfere with the free movement and rotation of wand 130.

Preferentially, cavity 410 features docking seat 510 that has multiple diameters such that docking plug 310 may be firmly inserted into cavity 410, but the smaller distal diameter of cavity 410 prevents docking plug 310 from being inadvertently pulled out removed from cavity 410 through normal anticipated use of the invention, but the smaller distal diameter of cavity 410 does not prevent the average human from intentionally dislodging docking plug 310 from cavity 410 without strenuous exertion.

Preferentially, handle 110 is operated by a human. Ergonomic indentation 120 on handle 110 may increase the comfort of the operator and may allow the operator to control handle 110 with greater precision and dexterity, given the increased torque the operator may be allowed to apply to handle 110 through the ergonomic indentation 120.

Preferred sizes and configurations for certain exemplar embodiments are discussed throughout and alternative sizes and arrangements are possible; these noted measurements and configurations are merely those of certain exemplar embodiments.

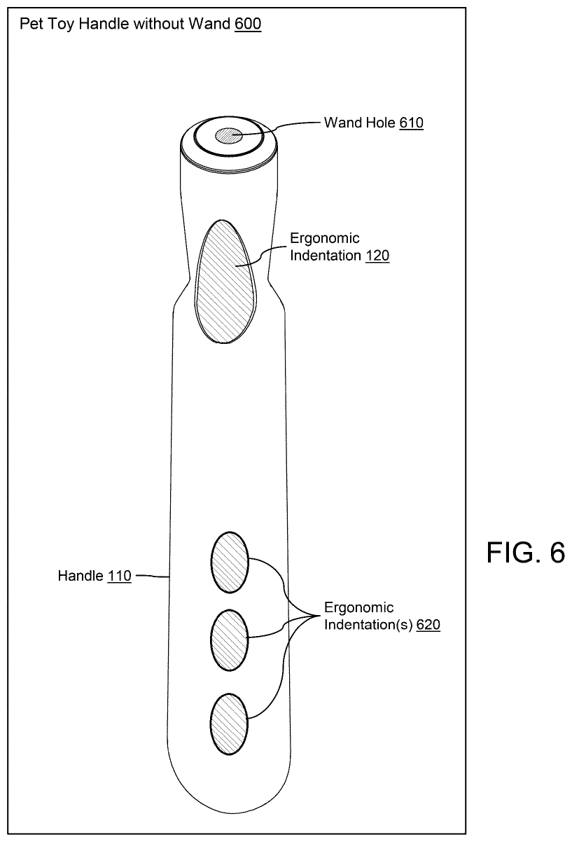

FIG. 6 is a perspective view of an exemplary embodiment of the present invention illustrating a pet toy handle featuring an opening on its distal end to accept the insertion of pet toy wands, and multiple ergonomic indentations in accordance with the present invention.

More specifically, FIG. 6 is a perspective view of an exemplary embodiment of the present invention illustrating a pet toy handle featuring an opening on its distal end 610 to accept the insertion of pet toy wands, distal ergonomic indentation 120 and multiple proximal ergonomic indentations 620 in accordance with the present invention.

Referring to FIG. 6, a pet toy handle apparatus 600 may include a distal end opening 610 to accept the insertion of pet toy wands, ergonomic indentation 610 on the distal end, and multiple ergonomic indentations 620 on the proximal end in accordance with the present invention.

As shown in FIG. 6, handle 110 may feature ergonomic indentation 120 on its distal end.

As shown in FIG. 6, handle 110 may feature multiple ergonomic indentation(s) 620 on its proximal end.

Preferred sizes and configurations for certain exemplar embodiments are discussed throughout and alternative sizes and arrangements are possible; these noted measurements and configurations are merely those of certain exemplar embodiments.

Preferentially, handle 110 has multiple proximal end ergonomic indentation(s) 620 that are located 1 inch, 1.5 inches, and 2 inches from the proximal end of handle 110. Proximal end ergonomic indentation(s) 620 may have a depth between 0.5 mm and 1.5 mm. Alternative sizes are possible, these noted measurements are merely those of preferred exemplar embodiments.

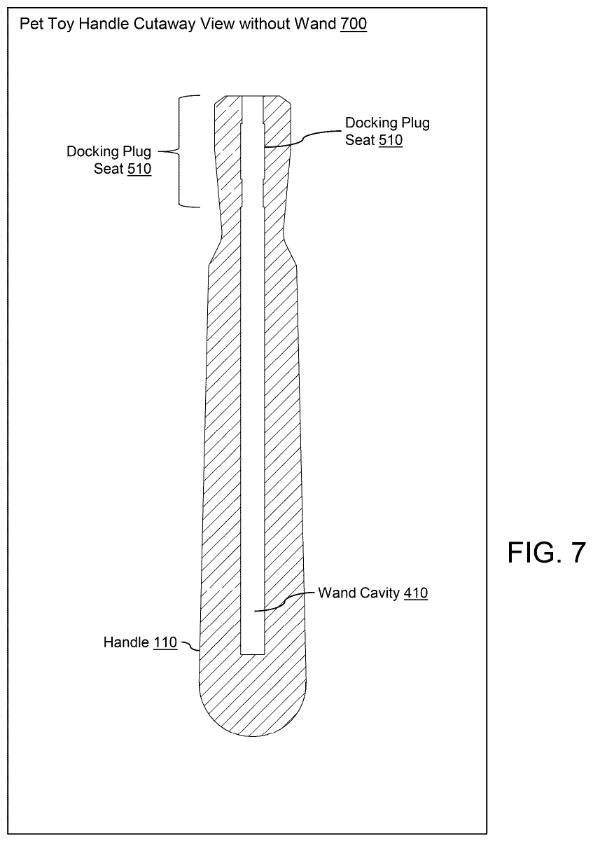

FIG. 7 is a sideways/sagittal cross-sectional view of an exemplary embodiment of the present invention illustrating a pet toy handle featuring a centered internal longitudinal cavity which is open on the distal end and closed on the proximal end, the longitudinal cavity further featuring a multi-diameter portion at the distal end to serve as a docking seat for accepting and snuggly nesting a docking plug in accordance with the present invention.

More specifically, FIG. 7 is a sideways/sagittal cross-sectional view of an exemplary embodiment of the present invention illustrating pet toy handle 110 featuring a centered internal longitudinal cavity 410 which is open on the distal end and closed on the proximal end, the longitudinal cavity further featuring a multi-diameter portion at the distal end to serve as a docking seat 510 for accepting and snuggly nesting a docking plug in accordance with the present invention.

Referring to FIG. 7, a pet toy handle without a wand or docking plug 700 may include a handle 110 having longitudinal cavity 410 including a docking plug seat 510 that has multiple diameters such that docking plug seat 510 may accept and through static friction securely hold insertable docking plugs.

As shown in FIG. 7, handle 110 may not include an ergonomic indentation.

Preferentially, handle 110 may have a closed proximal end.

Preferentially, cavity 410 features docking seat 510 that has multiple diameters such that a docking plug may be firmly inserted into cavity 410, but the stepped diameter of docking plug seat 510 may prevent a docking plug from being inserted too far into cavity 410 such that the walls of cavity 410 could interfere with the free movement and rotation of a pet toy wand.

Preferentially, cavity 410 features docking seat 510 that may have multiple diameters such that a docking plug may be firmly inserted into cavity 410, but the smaller distal diameter of cavity 410 prevents a docking plug from being inadvertently pulled out and removed from cavity 410 through normal anticipated use of the invention, but the smaller distal diameter of cavity 410 does not prevent the average human from intentionally dislodging a docking plug from cavity 410 without strenuous exertion.

Preferred sizes for handle 110 for use in preferred exemplar embodiments are discussed throughout and alternative sizes and arrangements are possible, these noted measurements and configurations are merely those of preferred exemplar embodiments.

Preferentially, docking plug seat 510 may have a generally cylindrical diameter of between 2 mm and 5 mm, with a central portion that has a diameter 0.5 mm larger than the rest of docking plug seat 510. Alternative sizes are possible, these noted measurements are merely those of preferred exemplar embodiments.

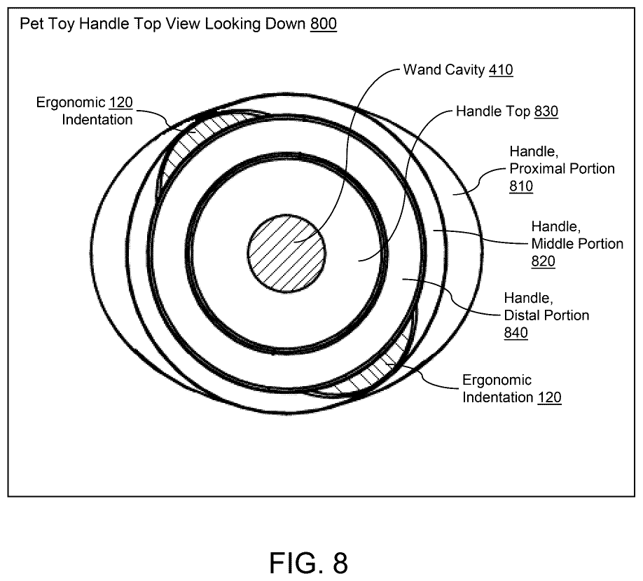

FIG. 8 is a perspective axial view looking directly at the distal end of an exemplary embodiment of the present invention illustrating a pet toy handle featuring a centered internal longitudinal cavity for the insertion of pet toy wands, where the longitudinal cavity is open on the distal end and closed on the proximal end, where the pet toy handle further has a multi-diameter, generally cylindrical, distal end with diametrically opposing ergonomic indentations near the distal end, and the proximal end of the pet toy handle having a generally elliptical cross section with its major axis radially offset from the ergonomic indentations in accordance with the present invention.

More specifically, FIG. 8 is a perspective axial view looking directly at the distal end of an exemplary embodiment of the present invention illustrating a pet toy handle (810, 820, 830, 840) featuring a centered internal longitudinal cavity 410 for the insertion of pet toy wands, where the longitudinal cavity 410 is open on the distal end and closed on the proximal end, where the pet toy handle further has a multi-diameter, generally cylindrical, distal end (830, 840) with diametrically opposing ergonomic indentations 120 near the distal end 840, and the proximal end 810 of the pet toy handle having a generally elliptical cross section with its major axis radially offset from the ergonomic indentations 120 in accordance with the present invention.

Referring to FIG. 8, a pet toy handle apparatus 800 may include centered internal longitudinal cavity 410 for the insertion of pet toy wands. Handle 110 may include flat top 830, generally cylindrical distal end 840, slightly larger middle portion 820, proximal end with a generally elliptical cross section 810. Middle portion 820 may have diametrically opposing ergonomic indentions 120 and proximal end 810 may be radially offset about its major axis from ergonomic indentions 120 such that handle 110 may be more comfortable for a user. Handle may also include longitudinal cavity 410, cavity 410 may be open on the distal end and closed on the proximal end.

Preferentially, handle top 830 is flat with a diameter of between 0.25 and 0.5 inches.

Preferentially, handle distal portion 840 is generally cylindrical with a diameter of between 0.25 and 0.5 inches.

Preferentially, handle middle portion 820 is generally cylindrical with a diameter of between 0.2 and 0.3 inches.

Preferentially, handle proximal portion 810 has a generally elliptical cross section with a tapered major axis of width of between 0.5 and 0.7 inches with the major axis radially offset from ergonomic indentations 120 by between 25 and 65 degrees.

Again, alternative sizes and arrangements are possible, these noted measurements and configurations are merely those of preferred exemplar embodiments.

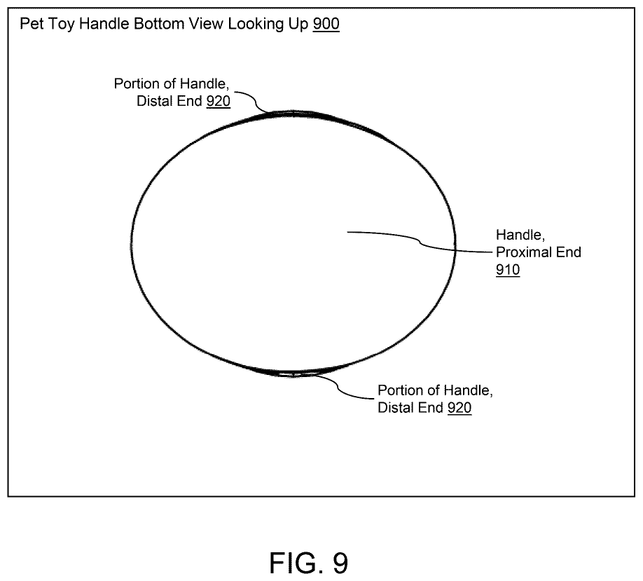

FIG. 9 is a perspective axial view looking directly at the proximal end of an exemplary embodiment of the present invention illustrating a pet toy handle featuring a closed proximal end which has a generally elliptical cross section, and a generally cylindrical distal end in accordance with the present invention.

More specifically, FIG. 9 is a perspective axial view looking directly at the proximal end 910 of an exemplary embodiment of the present invention illustrating a pet toy handle featuring a closed proximal end 910 which has a generally elliptical cross section, and a generally cylindrical distal end 920 in accordance with the present invention.

Referring to FIG. 9, a pet toy handle apparatus 900 may include closed proximal end 910 with a generally elliptical cross section and a generally cylindrical distal end 920.

Preferred sizes and configurations for preferred exemplar embodiments are discussed throughout and alternative sizes and arrangements are possible, these noted measurements and configurations are merely those of preferred exemplar embodiments.

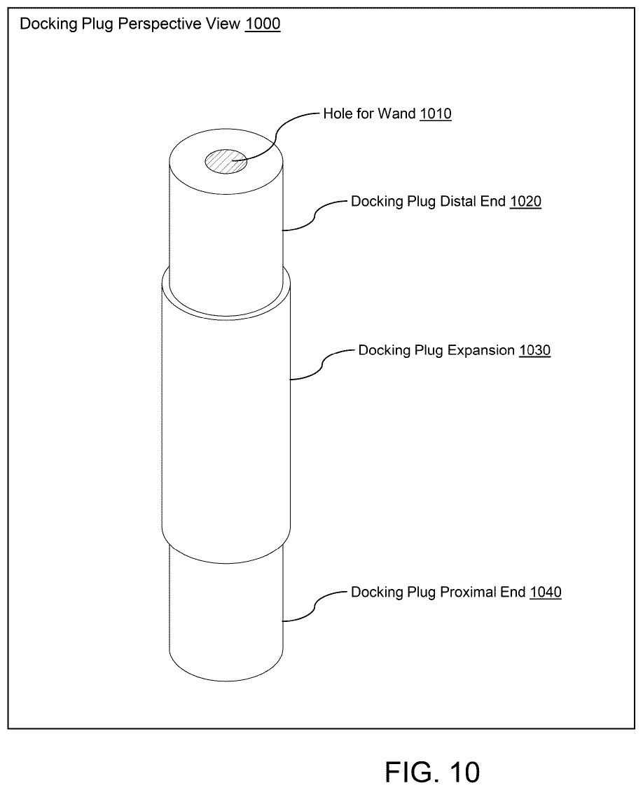

FIG. 10 is a perspective view of an exemplary embodiment of the present invention illustrating a docking plug with a longitudinal cavity for the insertion of a pet toy wand and a center portion having an expanded outer diameter to substantially match the diameter of a docking plug seat inside a longitudinal cavity of a pet toy handle such that the docking plug can be securely nested inside the handle in accordance with the present invention.

More specifically, FIG. 10 is a perspective view of an exemplary embodiment of the present invention illustrating docking plug 1000 featuring a longitudinal cavity 1010 for the insertion of a pet toy wand and a center portion 1030 having an expanded outer diameter to substantially match the diameter of a docking plug seat inside a longitudinal cavity of a pet toy handle such that the docking plug can be securely nested inside the handle in accordance with the present invention.

Referring to FIG. 10, docking plug 1000 may feature a centered longitudinal cavity 1010 for the insertion of a pet toy wand, docking plug expansion 1030, proximal end 1040, and distal end 1020.

Preferentially, cavity 1010 is open on both proximal end 1040 and distal end 1020.

Preferentially, docking plug proximal end 1040 and distal end 1020 have substantially similar diameter such that docking plug 1000 may be orientationally independent and the user would not have to distinguish between proximal end 1040 and distal end 1020 in ordinary use.

Preferentially, docking plug proximal end 1040 and distal end 1020 have substantially similar longitudinal length such that docking plug 1000 may be orientationally independent and the user would not have to distinguish between proximal end 1040 and distal end 1020 in ordinary use.

Preferentially, docking plug expansion 1030 has a larger diameter than docking plug proximal end 1040 and docking plug distal end 1020 such that docking plug 1000 may be inserted into a pet toy handle and securely nested into a docking plug seat.

Preferentially, docking plug expansion 1030 is situated equally distant from the docking plug proximal end 1040 and docking plug distal end 1020 such that docking plug 1000 may be orientationally independent and the user would not have to distinguish between proximal end 1040 and distal end 1020 in ordinary use.

Preferentially, docking plug proximal end 1040 and docking plug distal end 1020 may have a diameter of between 2 mm and 5 mm, docking plug expansion 1030 has a diameter 0.5 mm larger than docking plug proximal end 1040 and docking plug distal end 1020, alternative sizes and configurations are possible, these noted measurements are merely those of preferred exemplar embodiments.

Preferentially, docking plug expansion 1030 may have a sufficient longitudinal length to withstand the frictional forces experienced by inserting and removing docking plug 1000 from the docking plug seat and handle discussed above. A docking plug expansion is more likely to experience structure failure from said forces the greater the difference between the longitudinal length of docking plug expansion 1030 and the increased diameter of docking plug expansion compared to the diameter of docking plug distal end and docking plug proximal end.

Preferentially, docking plug expansion 1030 may have a longitudinal length of between 0.2 and 0.4 inches, docking plug proximal end 1040 has a longitudinal length of between 0.05 and 0.15 inches, and docking plug distal end 1020 may have a longitudinal length of between 0.05 and 0.15 inches, alternative sizes and configurations are possible, these noted measurements are merely those of preferred exemplar embodiments.

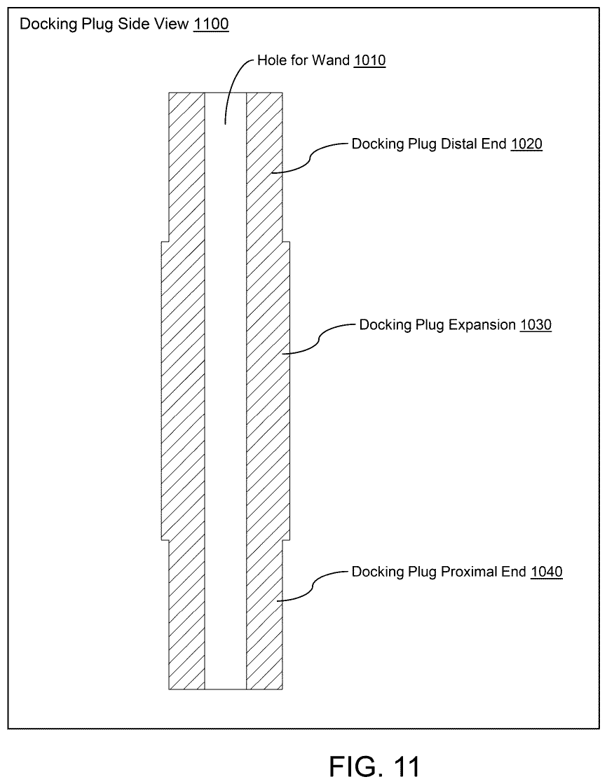

FIG. 11 is a sideways/sagittal cross-sectional view of an exemplary embodiment of the present invention illustrating a vertically symmetric docking plug such that its proximal and distal ends substantially match, allowing it to be orientation-independently inserted into a longitudinal cavity of a pet toy handle, said symmetric docking plug further having a longitudinal cavity for the insertion of a pet toy wand and a center portion having and an expanded outer diameter to substantially match the diameter of a docking plug seat inside of a longitudinal cavity of a pet toy handle such that the docking plug can be securely nested inside a pet toy handle in accordance with the present invention.

More specifically, FIG. 11 is a sideways/sagittal cross-sectional view of an exemplary embodiment of the present invention illustrating a vertically symmetric docking plug 1100 such that its proximal 1040 and distal ends 1020 substantially match, allowing it to be orientation-independently inserted into a longitudinal cavity of a pet toy handle, said symmetric docking plug further having a longitudinal cavity for the insertion of a pet toy wand and a center portion 1030 having and an expanded outer diameter to substantially match the diameter of a docking plug seat inside of a longitudinal cavity of a pet toy handle such that the docking plug can be securely nested inside a pet toy handle in accordance with the present invention.

Referring to FIG. 11, docking plug 1100 may feature a centered longitudinal cavity 1010 for the insertion of a pet toy wand, docking plug expansion 1030, proximal end 1040, and distal end 1020.

Preferentially, cavity 1010 may be open on both proximal end 1040 and distal end 1020.

Preferentially, docking plug proximal end 1040 and distal end 1020 may have substantially similar diameter such that docking plug 1100 may be orientationally independent and the user would not have to distinguish between proximal end 1040 and distal end 1020 in ordinary use.

Preferentially, docking plug proximal end 1040 and distal end 1020 may have substantially similar longitudinal length such that docking plug 1100 may be orientationally independent and the user would not have to distinguish between proximal end 1040 and distal end 1020 in ordinary use.

Preferentially, docking plug expansion 1030 may have a larger diameter than docking plug proximal end 1040 and docking plug distal end 1020 such that docking plug 1000 may be inserted into a pet toy handle and securely nested into a docking plug seat.

Preferentially, docking plug expansion 1030 may be situated equally distant from the docking plug proximal end 1040 and docking plug distal end 1020 such that docking plug 1000 may be orientationally independent and the user would not have to distinguish between proximal end 1040 and distal end 1020 in ordinary use.

Preferentially, docking plug proximal end 1040 and docking plug distal end 1020 have a diameter of between 2 mm and 5 mm, docking plug expansion 1030 has a diameter 0.5 mm larger than docking plug proximal end 1040 and docking plug distal end 1020.

Preferentially, docking plug expansion 1030 may have a sufficient longitudinal length withstand the frictional forces experienced by inserting and removing docking plug 1100 from the docking plug seat and handle discussed above. A docking plug expansion is more likely to experience structure failure from said forces the greater the difference between the longitudinal length of docking plug expansion 1030 and the increased diameter of docking plug expansion compared to the diameter of docking plug distal end and docking plug proximal end.

Preferentially, docking plug expansion 1030 may have a longitudinal length of between 0.2 and 0.4 inches, docking plug proximal end 1040 has a longitudinal length of between 0.05 and 0.15 inches, and docking plug distal end 1020 has a longitudinal length of between 0.05 and 0.15 inches, alternative sizes and configurations are possible, these noted measurements are merely those of preferred exemplar embodiments.

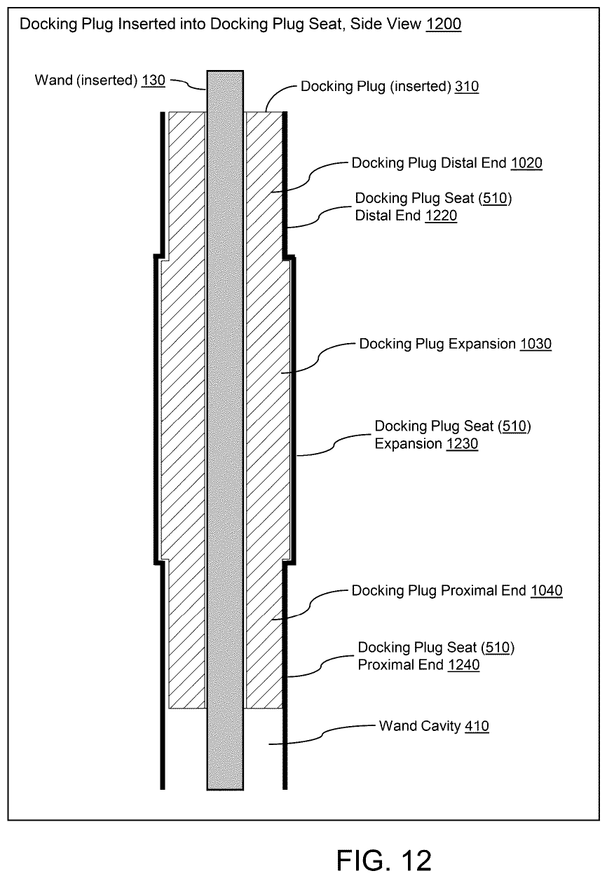

FIG. 12 is a sideways/sagittal cross-sectional view of an exemplary embodiment of the present invention illustrating a pet toy wand snugly inserted into a longitudinal cavity of a docking plug, which is securely nested within a docking plug seat of a centered internal longitudinal cavity of a pet toy handle in accordance with the present invention.

More specifically, FIG. 12 is a sideways/sagittal cross-sectional view of an exemplary embodiment of the present invention illustrating a pet toy wand 130 snugly inserted into a longitudinal cavity of a docking plug, which is securely nested within a docking plug seat 510 of a centered internal longitudinal cavity 410 of a pet toy handle in accordance with the present invention.

Referring to FIG. 12, an inserted docking plug system 1200 may include docking plug 310, wand 130, and cavity 410. Wand 130 may be inserted through an internal cavity of docking plug 310 and held in place through static friction, docking plug 310 may then in turn be snuggly nested in docking plug seat 510 inside of cavity 410 and held in place through static friction and mated geometry of docking plug seat 510 and docking plug 310.

As shown in FIG. 12, a cavity 410 may include docking plug seat 510 which may include docking plug seat distal end 1220, docking plug seat expansion 1230, and docking plug proximal end 1240.

As shown in FIG. 12, the diameter of docking plug seat expansion 1230 may substantially match the diameter of docking plug expansion 1030 such that docking plug 310 can snuggly secured within cavity 410 through static friction.

As shown in FIG. 12, the diameter of docking plug seat distal end 1220 may substantially match the diameter of docking plug distal end 1020 such that docking plug 310 can snuggly secured within cavity 410 through static friction.

As shown in FIG. 12, the diameter of docking plug seat proximal end 1240 may substantially match the diameter of docking plug proximal end 1040 such that docking plug 310 can snuggly secured within cavity 410 through static friction.

Preferentially, cavity 410 features docking seat 510 that may have multiple diameters such that docking plug 310 may be firmly inserted into cavity 410, but the stepped diameter of docking plug seat 510 may prevent docking plug 310 from being inserted too far into cavity 410 such that the walls of cavity 410 could interfere with the free movement and rotation of wand 130.

Preferentially, cavity 410 features docking seat 510 that may have multiple diameters such that docking plug 310 may be firmly inserted into cavity 410, but the smaller distal diameter of cavity 410 may prevent docking plug 310 from being inadvertently pulled out removed from cavity 410 through normal anticipated use of the invention, but the smaller distal diameter of cavity 410 does not prevent the average human from intentionally dislodging docking plug 310 from cavity 410 without strenuous exertion.

Preferentially, docking plug proximal end 1040 and distal end 1020 may have substantially similar diameters such that docking plug 1000 may be orientationally independent and the user would not have to distinguish between proximal end 1040 and distal end 1020 in ordinary use.

Preferentially, docking plug proximal end 1040 and distal end 1020 may have a substantially similar longitudinal length such that docking plug 1000 may be orientationally independent and the user would not have to distinguish between proximal end 1040 and distal end 1020 in ordinary use.

Preferentially, docking plug expansion 1030 may have a larger diameter than docking plug proximal end 1040 and docking plug distal end 1020 such that docking plug 1000 may be inserted into a pet toy handle and securely nested into a docking plug seat.

Preferentially, docking plug expansion 1030 may be situated equally distant from the docking plug proximal end 1040 and docking plug distal end 1020 such that docking plug 1000 may be orientationally independent and the user would not have to distinguish between proximal end 1040 and distal end 1020 in ordinary use.

Preferentially, docking plug proximal end 1040 and docking plug distal end 1020 may have a diameter of between 2 mm and 5 mm, docking plug expansion 1030 may have a diameter 0.5 mm larger than docking plug proximal end 1040 and docking plug distal end 1020, alternative sizes and configurations are possible, these noted measurements are merely those of preferred exemplar embodiments.

Preferentially, docking plug expansion 1030 may have a sufficient longitudinal length withstand the frictional forces experienced by inserting and removing docking plug 310 from the docking plug seat and handle discussed above. A docking plug expansion is more likely to experience structure failure from said forces the greater the difference between the longitudinal length of docking plug expansion 1030 and the increased diameter of docking plug expansion compared to the diameter of docking plug distal end and docking plug proximal end.

Preferentially, docking plug expansion 1030 may have a longitudinal length of between 0.2 and 0.4 inches, docking plug proximal end 1040 has a longitudinal length of between 0.05 and 0.15 inches, and docking plug distal end 1020 may have a longitudinal length of between 0.05 and 0.15 inches, alternative sizes and configurations are possible, these noted measurements are merely those of preferred exemplar embodiments.

Preferentially, docking plug proximal end 1040 and distal end 1020 may have substantially similar diameter such that docking plug 1000 may be orientationally independent and the user would not have to distinguish between proximal end 1040 and distal end 1020 in ordinary use.

Preferentially, docking plug proximal end 1040 and distal end 1020 may have substantially similar longitudinal length such that docking plug 1000 may be orientationally independent and the user would not have to distinguish between proximal end 1040 and distal end 1020 in ordinary use.

Preferentially, docking plug expansion 1030 may have a larger diameter than docking plug proximal end 1040 and docking plug distal end 1020 such that docking plug 1000 may be inserted into a pet toy handle and securely nested into a docking plug seat.

Preferentially, docking plug expansion 1030 may be situated equally distant from the docking plug proximal end 1040 and docking plug distal end 1020 such that docking plug 1000 may be orientationally independent and the user would not have to distinguish between proximal end 1040 and distal end 1020 in ordinary use.

Preferentially, docking plug proximal end 1040 and docking plug distal end 1020 may have a diameter of between 2 mm and 5 mm, docking plug expansion 1030 may have a diameter 0.5 mm larger than docking plug proximal end 1040 and docking plug distal end 1020, alternative sizes and configurations are possible, these noted measurements are merely those of preferred exemplar embodiments.

Preferentially, docking plug expansion 1030 may have a sufficient longitudinal length withstand the frictional forces experienced by inserting and removing docking plug 1000 from the docking plug seat and handle discussed above. A docking plug expansion is more likely to experience structure failure from said forces the greater the difference between the longitudinal length of docking plug expansion 1030 and the increased diameter of docking plug expansion compared to the diameter of docking plug distal end and docking plug proximal end.

Preferentially, docking plug expansion 1030 may have a longitudinal length of between 0.2 and 0.4 inches, docking plug proximal end 1040 has a longitudinal length of between 0.05 and 0.15 inches, and docking plug distal end 1020 has a longitudinal length of between 0.05 and 0.15 inches, alternative sizes and configurations are possible, these noted measurements are merely those of preferred exemplar embodiments.

Preferentially, docking plug expansion 1030 may have a longitudinal length that substantially matches the longitudinal length of docking plug seat expansion 1230 such that docking plug 310 may be more resistant to movement in the event wand 130 is pushed or pulled during use.

Preferentially, docking plug distal end 1020 may have a longitudinal length that substantially matches the longitudinal length of docking plug seat distal end 1220 such that when inserted docking plug 310 is flush with the top of the pet toy handle, however this is not necessary.

Preferred sizes and configurations for preferred exemplar embodiments are discussed throughout and alternative sizes and arrangements are possible, these noted measurements and configurations are merely those of preferred exemplar embodiments.

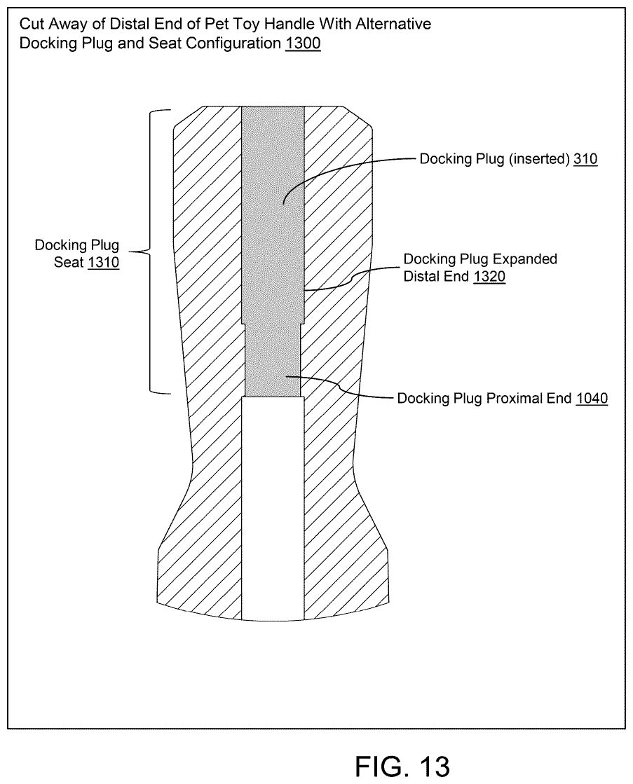

FIG. 13 is a sideways/sagittal cross-sectional view of an exemplary embodiment of the present invention illustrating an asymmetric, orientation-dependent docking plug with an expanded distal end inserted into and securely nested within a docking plug seat inside of a longitudinal cavity of a pet toy handle in accordance with the present invention.

More specifically, FIG. 13 is a sideways/sagittal cross-sectional view of an exemplary embodiment of the present invention illustrating an asymmetric, orientation-dependent docking plug 1300 with an expanded distal end 1320 inserted into and securely nested within a docking plug seat 1310 inside of a longitudinal cavity of a pet toy handle in accordance with the present invention.

Referring to FIG. 13, a distal end of a pet toy handle with an inserted asymmetric docking plug 1300 may include docking plug 310 and docking plug seat 1310. Docking plug 310 may include docking plug expanded distal end 1320 and docking plug proximal end 1040. Docking plug 130 may then in turn be snuggly nested in docking plug seat 510 inside of cavity 410.

As shown in FIG. 13 docking plug seat 1310 may include multiple diameters that substantially match the diameter of docking plug expanded distal end 1320 and docking plug proximal end 1040 such that docking plug 310 will be snuggly secured through static friction.

Preferentially, docking plug seat 1310 may have multiple diameters such that docking plug 310 may be firmly inserted, but the varying diameter of docking plug seat 1310 and docking plug proximal end 1040 may prevent docking plug 310 from being inserted too far into the handle that the walls of the handle cavity could interfering with the free movement and rotation of the pet toy wand.

Preferentially, docking plug proximal end 1040 and docking plug expanded distal end 1320 may have substantially different diameters such that docking plug 310 is orientationally dependent and the user would be capable of easily distinguishing between proximal end 1040 and distal end 1320 in ordinary use.

Preferentially, docking plug proximal end 1040 may have a diameter of between 2 mm and 5 mm and docking plug expanded distal end 1320 has a diameter 0.5 mm larger than docking plug proximal end 1040. Alternative sizes and configurations are possible, these noted measurements are merely those of preferred exemplar embodiments.

Preferentially, docking plug expanded distal end 1040 may have a longitudinal length of between 0.2 and 0.4 inches and docking plug proximal end 1040 may have a longitudinal length of between 0.15 and 0.3 inches. Alternative sizes and configurations are possible, these noted measurements are merely those of preferred exemplar embodiments.

Preferred sizes and configurations for preferred exemplar embodiments are discussed throughout and alternative sizes and arrangements are possible, these noted measurements and configurations are merely those of preferred exemplar embodiments.

The docking plug portion(s) of embodiments may be disconnected or pulled out of the docking plug hole(s) of the handle portion of embodiments. The handle portion of embodiments may therefore accept many different plugs with many different associated wands and/or toys.

### Manufacturing

Both the handle portion and plug portion(s) of embodiments may be made from TPR/TPE (thermoplastic rubber or thermoplastic elastomer), rubbers, plastics, wood composite materials, or any variation or substitute thereof known by those knowledgeable in the art.

### Variations

The handle portion of embodiments may be tapered and/or formed into an ergonomic shape for ease of use, as shown in the Figures.

Both the handle portion and plug portion(s) of embodiments may be colorized, differently or identically.

The handle portion of embodiments may comprise more than one docking plug hole and may therefore accept and hold more than one plug and more than one associated toy wand.

Although the present disclosure provides certain embodiments and applications, other embodiments apparent to those of ordinary skill in the art, including embodiments that do not provide all of the features and advantages set forth herein, are also within the scope of this disclosure.

The foregoing disclosure has been set forth merely to illustrate the invention and is not intended to be limiting. It will be appreciated that modifications, variations, and additional embodiments are covered by the above teachings and within the purview of the appended claims without departing from the spirit and intended scope of the invention. Since modification of the disclosed embodiments incorporating the spirit and substance of the invention may occur to persons skilled in the art, the invention should be construed to include everything within the scope of the appended claims and equivalents thereof.

The invention claimed is:

1. A pet toy apparatus comprising:
A pet toy handle having a tapered diameter along its length, said tapered diameter broader at the proximal end of the handle and narrower at the distal end of the handle;
said handle having a generally cylindrical distal end;
said handle having a proximal end with a generally elliptical cross section;
said handle having a centered internal longitudinal cavity that is open at the distal end and closed at the proximal end of the handle; and
wherein said cavity has an internal notched docking seat configured to accept a pet toy wand.

2. The pet toy apparatus of claim 1, further comprising a pet toy wand configured to accept at least one pet attractor at the distal end of the wand, and where the wand has a diameter at its proximal end that substantially matches the diameter of the cavity of the handle, such that the wand can be inserted into and affixed inside the cavity.

3. The pet toy apparatus of claim 2, wherein the notched docking seat is located between 5 and 12 mm from the distal end of the cavity, and where the notched docking seat is between 0.1 mm and 0.2 mm larger in diameter than the cylindrical diameter of the rest of the cavity.

4. The pet toy apparatus of claim 3, wherein the wand further comprise an external notched docking plug enlargement at the proximal end of the wand that substantially mirrors the shape of the notched docking seat and is configured to snap into the notched docking seat.

5. The pet toy apparatus of claim 4, wherein the handle is made of a suitably elastic material such that the docking plug may be repeatedly inserted into and or removed from the docking seat without permanently altering the diameter of the docking seat or otherwise compromising the integrity of the docking plug and the docking seat.

6. The pet toy apparatus of claim 1, where said handle has an ergonomic indentation near the distal end of the handle.

7. The pet toy apparatus of claim 6, where said ergonomic indentation has a depth of between 0.5 mm and 1.5 mm.

8. The pet toy apparatus of claim 1, where the handle has a length of between 4 and 6 inches.

9. The pet toy apparatus of claim 1, where the tapered diameter is between 0.5 and 0.7 inches.

10. The pet toy apparatus of claim 1, where said cavity has a substantially cylindrical diameter of between 2 mm and 5 mm and a length inside the handle of between 2 and 4 inches.

11. The pet toy apparatus of claim 2, where the wand has a length of between 6 and 24 inches.

12. A pet toy apparatus comprising:
a pet toy handle,
said handle having a tapered diameter along its length, said tapered diameter being broader at the proximal end of the handle and narrower at the distal end of the handle,
said handle having a generally cylindrical distal end,
said handle having a proximal end with a generally elliptical cross section,
said handle having a centered internal longitudinal cavity that is open at the distal end and closed at the proximal end of the handle, and
wherein said cavity has an internal notched docking seat configured to accept a pet toy wand;
a docking plug configured to be affixed in the distal end the cavity such that when it is inserted, its distal end is substantially flush with the distal end of the handle,
said docking plug having a diameter that substantially matches the diameter of the cavity,
said docking plug having a centered internal longitudinal cavity,
said docking plug having an externally notched enlargement that substantially matches the internally notched docking seat of the longitudinal cavity in the handle, and
said docking plug having a length less than the length of the cavity; and
a pet toy wand interoperably affixed to the docking plug at the proximal end of the wand and interoperably connected to a pet attractor at the distal end of the wand,
said pet toy wand having a diameter that substantially matches the diameter of the longitudinal cavity of the handle.

13. The pet toy apparatus of claim 12, where said handle has an ergonomic indentation near the distal end of the handle.

14. A pet toy system comprising:
a pet toy handle having a tapered diameter along its length, said tapered diameter being broader at the proximal end of the handle and narrower at the distal end of the handle;
a pet toy wand having pet attractor at the distal end of the wand; and
means for connecting the proximal end of the pet toy wand to the distal end of the pet toy handle.

15. The pet toy system of claim 14, said handle comprising an ergonomic indentation near the distal end of the handle.

16. The pet toy system of claim 15, where said ergonomic indentation has a depth of between 0.5 mm and 1.5 mm.

17. The pet toy system of claim 14, where the handle has a length of between 4 and 6 inches.

18. The pet toy system of claim 14, where the tapered diameter is between 0.5 and 0.7 inches.

19. The pet toy system of claim 14, where the wand has a length of between 6 and 24 inches.
